(19) United States
(12) Patent Application Publication
(10) Pub. No.: US 2008/0143491 A1
(43) Pub. Date: Jun. 19, 2008

(54) Power Line Communication Interface Device and Method

(76) Inventor: Brian J. Deaver, Fallston, MD (US)

Correspondence Address: CAPITAL LEGAL GROUP, LLC, 1100 River Bay Road, Annapolis, MD, 21409, US

(21) Appl. No.: 11/610,026

(22) Filed: Dec. 13, 2006

(51) Int. Cl. G05B 11/01

(52) U.S. Cl. 340/310.11

(57) ABSTRACT

A system for providing communications with a plurality of power distribution equipment via a broadband over power line communication system that provides broadband internet access to a plurality of consumers is provided. In one embodiment, the system may include a computer system having executable program code executable to generate control messages for controlling the plurality of power distribution automation equipment and a plurality of interface devices, wherein each interface device is communicatively coupled to one or more of the plurality of power distribution equipment. The computer system may be configured to transmit control messages to the plurality of power distribution equipment via a communication path that includes the broadband over power line communication system and the plurality of interface devices.

### FIELD OF THE INVENTION

The present invention generally relates to methods and apparatus for providing utility data services, and more particularly to devices and methods for communicating utility data to one or more automated utility equipment via a broadband over power line data network.

### BACKGROUND OF THE INVENTION

Users are increasingly relying on immediate access to many types of data for their entertainment, work and communication needs. Users access cell phones to communicate over wireless communication networks. Entertainment appliances, such as televisions, receive cable signals to view television shows and movies on demand. Users access the internet to exchange e-mail communications and communicate audio, video, multimedia and textual data. Delivering these various data services requires a communications infrastructure.

One type of infrastructure being adapted to deliver broadband communication services to user premises is the power distribution system infrastructure. Power line communication systems include devices for transmitting data signals over power lines and may also utilize other communications media.

Power distribution systems may also include different types of automated power distribution equipment that may include remote intelligent devices. A few examples of automated power distribution equipment include capacitor controllers, switchgear and intelligent meters. This type of equipment is normally remotely located and often cannot properly function, and/or be fully utilized, without communicative control. Consequently, one challenge in using such equipment is providing communication with the device. One solution is to install communications media (e.g., fiber optic cables) or to provide a wireless link (e.g., a pager or mobile telephone transceiver). However, such solutions can be very expensive and may prohibit some installations—due to technical reasons or due to costs.

The present invention contemplates the use of existing power line communication systems (PLCSs) that, for example, provide consumers and business with high speed broadband Internet access to enable utilities remote access and control of automated power distribution equipment (APDE). However, in order to use an existing PLCS for such communications, the APDE must be interfaced to the PLCS. Because there are various types of APDE and PLCSs, it is desirable for such an interface device to be flexible. One or more embodiments of the present invention provide an interface device that interfaces communications between one or more types of APDE and a power line communication system. These and other advantages may be provided by one or more embodiments of the present invention.

### SUMMARY OF THE INVENTION

The present invention provides a system for providing communications with a plurality of power distribution equipment via a power line communication system that provides internet access to a plurality of consumers. In one embodiment, the system may include a computer system having executable program code executable to generate control messages for controlling the plurality of power distribution automation equipment and a plurality of interface devices, wherein each interface device is communicatively coupled to one or more of the plurality of power distribution equipment. The computer system may be configured to transmit control messages to the plurality of power distribution equipment via a communication path that includes the broadband over power line communication system and the plurality of interface devices.

The invention will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram of a example power line communication system relying on a variety of communications media, including power lines, wired and wireless media;

FIG. 2 illustrates an implementation of an example embodiment of an interface device according to the present invention;

FIG. 3 is a block diagram of the example embodiment of an interface device according to the present invention;

FIG. 4 illustrates an implementation of another example embodiment of an interface device according to the present invention

FIG. 5 is a block diagram of the other example embodiment of an interface device according to the present invention;

FIG. 6a is an architectural diagram illustrating deployment of an example embodiment of an interface device according to the present invention

FIG. 6b is an architectural diagram illustrating deployment of another example embodiment of an interface device according to the present invention;

FIG. 7 is a block diagram of an example embodiment of a backhaul node;

FIG. 8 illustrates a deployment of the example embodiment of the backhaul node according to the present invention;

FIG. 9 is a block diagram of an example embodiment of an access node according to the present invention;

FIG. 10 illustrates a deployment of the example embodiment of the access node according to the present invention; and

FIG. 11 is a partial network diagram showing an example topology of a communication system according to an example embodiment of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, data and network protocols, software products and systems, enterprise applications, PLCS, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, PLCS, software products and systems, operating systems, development interfaces, and hardware are omitted so as not to obscure the description of the present invention.

Communication System

Typically, broadband over power line networks may provide high speed broadband internet access, mobile telephone communications, broadband communications, streaming video and audio services, and other communication services to each home, building or other structure, and to each room, office, apartment, or other unit or sub-unit of a multi-unit structure. Such power line networks may provide these communication services to mobile and stationary devices in outdoor areas such as customer premises yards, parks, stadiums, and also to public and semi-public indoor areas such as subway trains, subway stations, train stations, airports, restaurants, public and private automobiles, bodies of water (e.g., rivers, bays, inlets, etc.), building lobbies, elevators, etc.

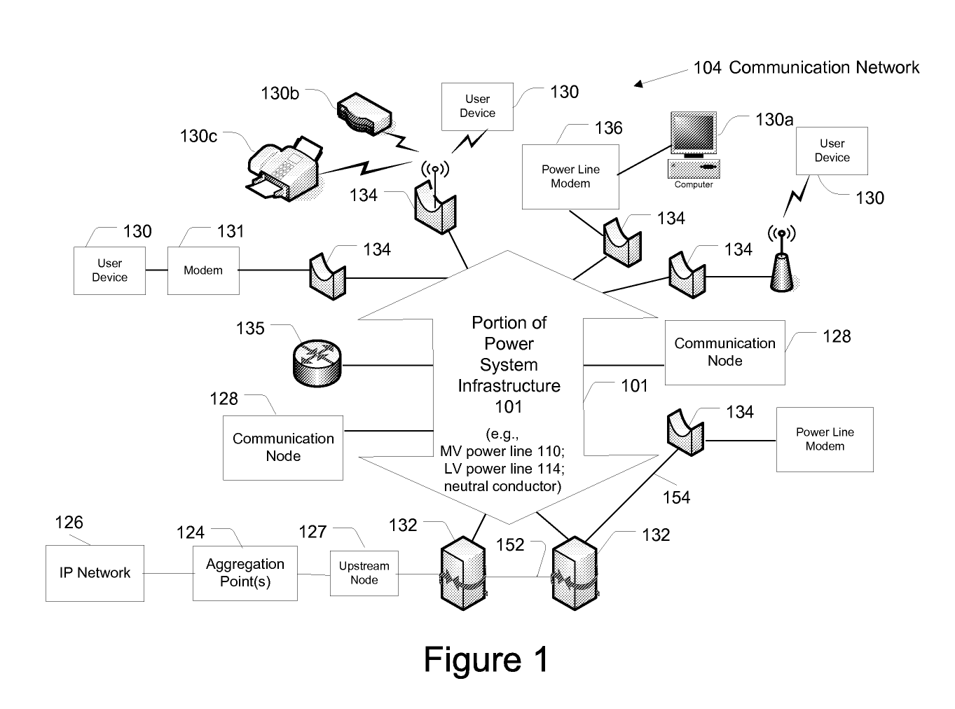

FIG. 1 shows the components of a communication network 104 that may rely, in part, on portions of a power system infrastructure 101 to carry data communications. Communication network 104 includes a plurality of communication nodes 128 which form communication links using power lines and other communication media. Various user devices 130 and power line communication devices may transmit and receive data over the links to communicate via IP network 126. One type of communication node 128 may be a backhaul node 132. Another type of communication node 128 may be an access node 134. Another type of communication node 128 may be a repeater node 135. Some embodiments of a given node 128 may serve as a backhaul node 132, access node 134, and/or repeater node 135.

A communication link is formed between two communication nodes 128 over a communication medium. Some links may be formed over MV power lines 110. Some links may be formed over the LV power lines 114. Other links may be gigabit-Ethernet links 152, 154 formed, for example, using a fiber optic cable. Thus, some links may be formed using a portion 101 of the power system infrastructure, while other links may be formed over another communication media, (e.g., a coaxial cable, twisted pair, a T-1 line, a fiber optic cable, wirelessly (e.g., IEEE 802.11 a/b/g, 802.16, 1G, 2G, 3G, or satellite such as WildBlue®)). The links formed by wired or wireless media may occur at any point along a communication path between a backhaul node 132 and a user device 130. Some links may comprise wired Ethernet, multipoint microwave distribution system (MMDS) standards, DOCSIS (Data Over Cable System Interface Specification) signal standards or another suitable communication method. The wireless links may also use any suitable frequency band. In one example, frequency bands are used that are selected from among ranges of licensed frequency bands (e.g., 6 GHz, 11 GHz, 18 GHz, 23 GHz, 24 GHz, 28 GHz, or 38 GHz band) and unlicensed frequency bands (e.g., 900 MHz, 2.4 GHz, 5.8 GHz, 24 GHz, 38 GHz, or 60 GHz (i.e., 57-64 GHz)).

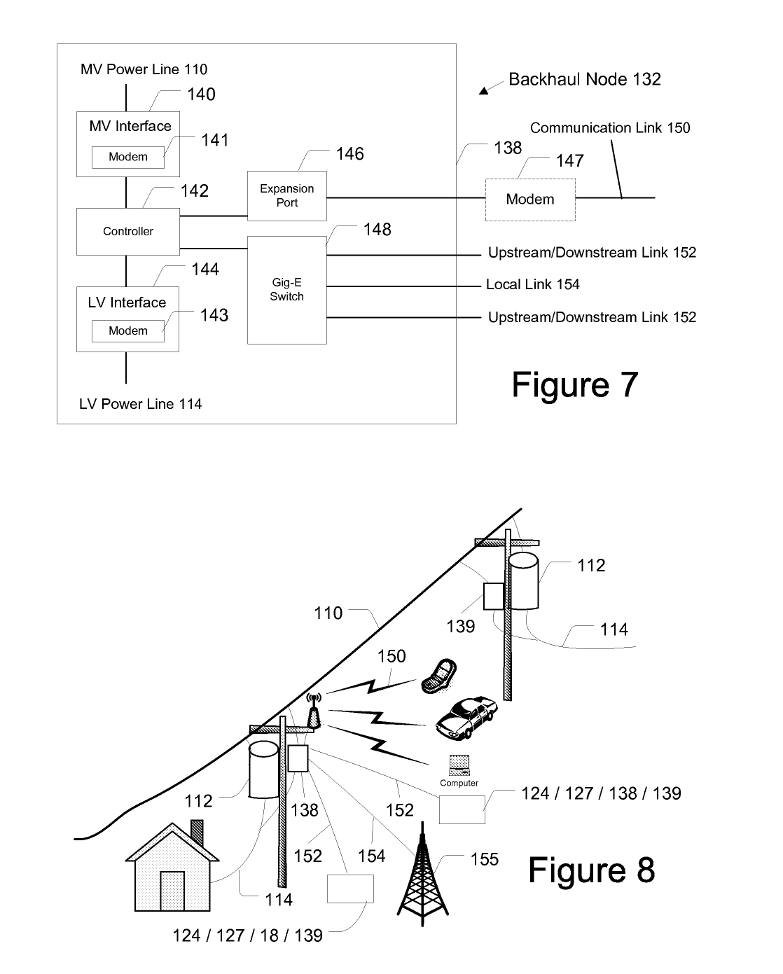

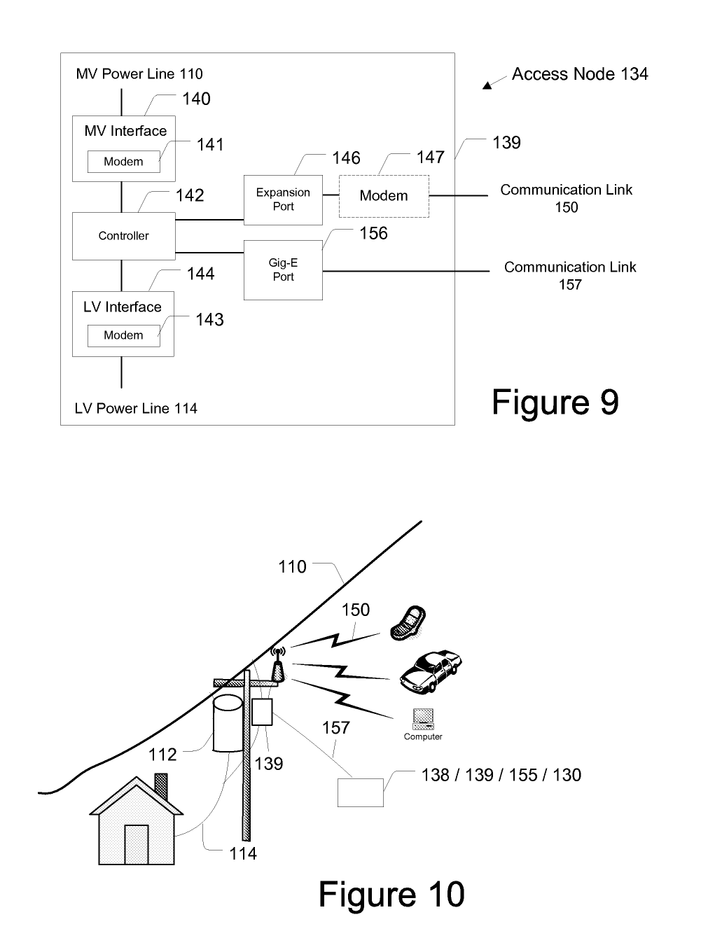

Each communication node 128 may be formed by one or more communication devices. Communication nodes which communicate over a power line medium include a power line communication device. Exemplary power line communication devices include a backhaul device 138 (see FIG. 7), an access device 139 (see FIG. 9), and a repeater 135. Communication nodes 128 that communicate wirelessly may include a mobile telephone cell site and/or a wireless access point having at least a wireless transceiver. Communication nodes that communicate over a coaxial cable may include a cable modem. Communication nodes that communicate over a twisted pair wire may include a DSL modem or other modem. A given communication node typically will communicate bi-directionally (either full duplex or half duplex), which may be over the same or different types of communication media. Accordingly, a communication node may include one, two or more communication devices.

A backhaul node 132 may serve as an interface between a power line portion (e.g., an MV power line 110) of the network 104 and a distribution node 127, which may be connected to an aggregation point 124 that provides a connection to an IP network 126 (e.g., the Internet). The communication network 104 may include a plurality of backhaul nodes 132. Upstream communications from user premises may be communicated to an access node 134, to a backhaul node 132, and then transmitted to an aggregation point 124 which is linked to the IP network 126. The backhaul node 132 may be coupled to the aggregation point 124 directly or indirectly (i.e., via one or more intermediate nodes). The backhaul node 132 may communicate with its upstream device via any of several alternative communication media, such as a fiber optic (digital or analog (e.g., Wave Division Multiplexed), coaxial cable, WiMAX, IEEE, 802.11, twisted pair and/or another wired or wireless media. Downstream communications from the IP network 126 typically are communicated through the aggregation point 124 to the backhaul node 132. The aggregation point 124 typically includes an Internet Protocol (IP) network data packet router and is connected to an IP network backbone, thereby providing access to an IP network 126 (i.e., can be connected to or form part of a point of presence or POP). Any available mechanism may be used to link the aggregation point 124 to the POP or other device (e.g., fiber optic conductors, T-carrier, Synchronous Optical Network (SONET), and wireless techniques).

An access node 134 may serve one or more user devices 130 or other network destinations. Upstream data may be sent, for example, from a user device 130 to an access node 134. The data may enter the network 104 along a communication medium (e.g., an LV power line 114 or wireless) coupled to an access node 134. The data is routed through the network 104 to a backhaul node 132, (or a local destination, such as another user device 130). Downstream data is similarly transmitted through the network 104 to a user device 130. Exemplary user devices 130 include a computer 130a, LAN, a WLAN, router 130b, Voice-over IP endpoint, game system, personal digital assistant (PDA), mobile telephone, digital cable box, power meter, gas meter, water meter, security system, alarm system (e.g., fire, smoke, carbon dioxide, security/burglar, etc.), stereo system, television, fax machine 130c, HomePlug residential network, or other device having a data interface. A user device 130 may include or be coupled to a modem to communicate with a given access node 134. Exemplary modems include a power line modem 136, a wireless modem 131, a cable modem, a DSL modem or other suitable transceiver device.

A repeater node 135 may receive and re-transmit data (i.e., repeat), for example, to extend the communications range of other communication elements. As a communication traverses through the communication network 104, backhaul nodes 132 and access nodes 134 also may serve as repeater nodes 135 (e.g., for other access nodes and other backhaul nodes 132). Repeaters may also be stand-alone devices without additional functionality. Repeaters 135 may be coupled to and repeat data on MV power lines or LV power lines (and, for the latter, be coupled to the internal or external LV power lines).

Communication Protocols:

As discussed, the communication network 104 may include communication links that may be formed by power lines, non-power line wired media, and wireless media. The links may occur at any point along a communication path between a backhaul node 132 and a user device 130, or between a backhaul node 132 and a distribution point 127 or aggregation point 124.

Communication among nodes 128 thus may occur using a variety of protocols and media. In one example, the nodes 128 may use time division multiplexing and implement one or more layers of the 7 layer open systems interconnection (OSI) model. For example, at the layer 3 ‘network’ level, the devices and software may implement switching and routing technologies, and create logical paths, known as virtual circuits, for transmitting data from node to node. Similarly, error handling, congestion control and packet sequencing can be performed at Layer 3. In one example embodiment, Layer 2 ‘data link’ activities include encoding and decoding data packets and handling errors of the ‘physical’ layer 1, along with flow control and frame synchronization. The configuration of the various communication nodes may vary. For example, the nodes coupled to power lines may include a modem that is substantially compatible with the HomePlug® 1.0, A/V, or Turbo standard. In various embodiments, the communications among nodes may be time division multiple access or frequency division multiple access.

Communication Devices:

Each communication node 128 may be formed by one or more communication devices. Communication nodes that communicate over a power line medium include a power line communication device. Exemplary power line communication devices include a backhaul device 138 (see FIGS. 7 and 8), an access device 139 (also referred to as a power line bridge) (see FIGS. 9 and 10), a repeater, and a power line modem 136 (see FIG. 1).

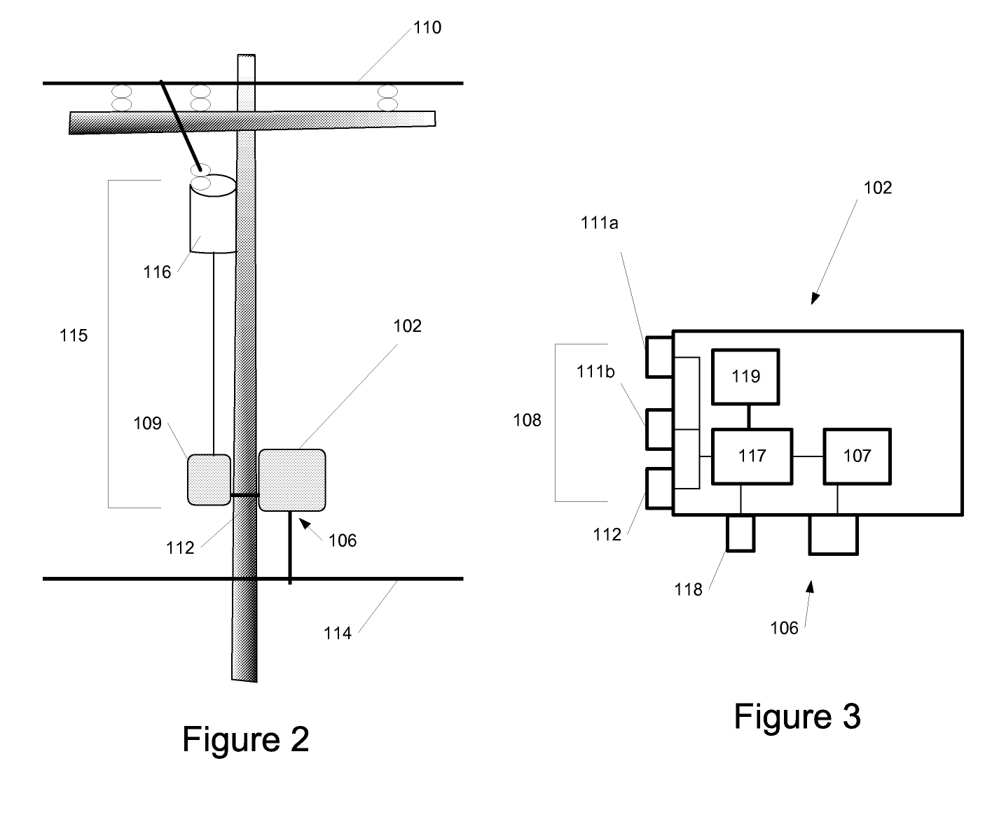

FIG. 2 illustrates the installation of an interface device 102 that may communicate over a PLCS via a power line communication device (not shown). The interface device 102 of this example embodiment is connected to, and is in communication with, an automated power distribution equipment controller 109. The automated equipment controller 109 typically comprises a microprocessor-based device that contains program code, logic, settings, communications and I/O to control distribution equipment such as, for example, a capacitor bank 116. The automated power distribution equipment controller 109 is connected to, and is in communication with, the power distribution equipment 116, which in this example embodiment comprises a capacitor bank 116. Thus, as used herein automated power distribution equipment 115 may include a controller and equipment which may physically separated (as shown) or integrated in one device or housing. The controller 109 may comprise a programmable logic controller, a remote terminal unit, or other control unit that facilitates communications for and control of the power distribution equipment. In addition, in some embodiments one controller 109 may be communicatively coupled to multiple pieces of equipment 116 for control thereof. The interface device 102 facilitates communication between the power line communication system 104, which communicates over the LV power lines 114, and the power distribution automated equipment 115 (more specifically, the automated power distribution equipment controller 109). The automated power distribution equipment controller 109, the interface device 102, and (if necessary) the equipment 116, may be connected to and powered by the LV power line 114.

FIG. 3 illustrates one example embodiment of the interface device 102 of FIG. 2. In this embodiment, the interface device 102 includes an equipment interface 108 that is configured to communicate with the automated power distribution equipment 115. The interface device 102 also provides a network interface 106 that is configured to communicate over the LV power lines 114.

The interface device 102 may include a controller 117 that is in communication with both the equipment interface 108 and the network interface 106. The controller 117 may be configured to control the flow of data to and from the automation equipment 115. The controller 117 may include memory 119 integrated therein or external to the controller 117. The memory may include programmable code that is executable by the controller 117 for controlling the operation of the interface device 102. For example, the controller 117 may employ an automated process to learn and store the Distributed Network Protocol (DNP) address(es) of the automated equipment(s) 115 (i.e., controller 109) to which it is connected. The interface device 102 may then advertise (transmit) the address (e.g., IP address) of the interface device 102 and the associated serial DNP address of the automated equipment 115 via the network interface 106 over the LV power line 114. In addition, the interface device 102 may re-advertise (transmit) its address and associated serial DNP address(es) on the LV power line 114 when the interface device 102 or its Dynamic Host Configuration Protocol (DHCP) server reboot and it is assigned a different IP address. Such advertisements (transmissions) may facilitate the interface device 102 being provisioned onto the PLCS network (i.e., allows the PLCS network and its devices to recognize the interface device 102 and permit communications). The memory 119 of the interface device 102 may include address information stored therein. The address information may include address data associated with the power distribution equipment 115 to which it is connected and/or address data associated with another interface device 102 for which the interface device 102 repeats (over the low voltage power line 1 14). While not shown, the interface device 102 also may include a configuration port 118 allowing personnel to connect to and communicate with the interface device 102 in order to control the connected automated power distribution equipment 115 and/or request status data and stored data therefrom.

The network interface 106 comprises a modem for communicating via the PLCS. In this embodiment, the network interface 106 includes a HomePlug compatible modem (i.e., chip set) for communicating via the LV power lines. Other embodiments may include a cable modem, a wireless modem, a DSL modem (e.g., for communicating over a twisted pair) or other modem suitable for the available medium. The network interface 106 may be conductively, inductively, or capacitively connected to one or both energized LV conductors and/or the neutral conductor.

The equipment interface 108 of this example embodiment includes two serial ports 111a and 111b that may be simultaneously connected to two different pieces the power distribution automated equipment 115 (e.g., the controller 109). The equipment interface 108 may further include a model RJ-45 Ethernet port 112 that connects to equipment 115 that employs an Ethernet connection. All the ports 111a, 111b, and 112 may be used independently and simultaneously. In an alternate embodiment, the equipment interface 108 may provide a plurality of serial or Ethernet ports alone or in combination with each other. Providing an equipment interface 108 that includes both serial and Ethernet ports allows greater flexibility in the type of data signal and equipment with which the device 102 can communicate. In other embodiments, the equipment interface 108 may additionally include other types of ports such as, for example, a wireless port (e.g., an IEEE 802.11 or Bluetooth® transceiver) a twisted pair modem, or a fiber optic transceiver. During operation controller 117 controls the flow of data between the equipment interface 108 (coupled to the power distribution automated equipment 115) and the network interface (connected to the PLCS). Data also may be buffered in the memory 119 during communications.

The automated equipment 115 depicted in FIG. 2 comprises a controller 109 and capacitor bank 116. Those skilled in the art will recognize that there are other types of automation equipment 115 may be interfaced to a PLCS by the present invention. One or more embodiments of the present invention may be facilitate communications for other types of automated power distribution equipment such as, for example a recloser, a sectionalizer, an automated (e.g., motor operated) disconnect switch, an automated switchgear, a voltage regulator, a current and/or voltage sensor device, a relay, a substation meter, a power quality meter, a power usage meter, and others. These devices 115 may include a controller 109 or be coupled to a programmable logic controller, a remote terminal unit, or other control unit that facilitates communications for and control of the equipment 115. In some instances the communications are for control of the equipment 115 and in other instances (or additionally) communications may allow the utility to provide information to and receive information from the device 115. Such received information may include, for example, status information (e.g., whether a switch, recloser, capacitor bank, etc. is engaged on not engaged) and/or parameter data (e.g., voltage, current, power factor or other data from a sensor device).

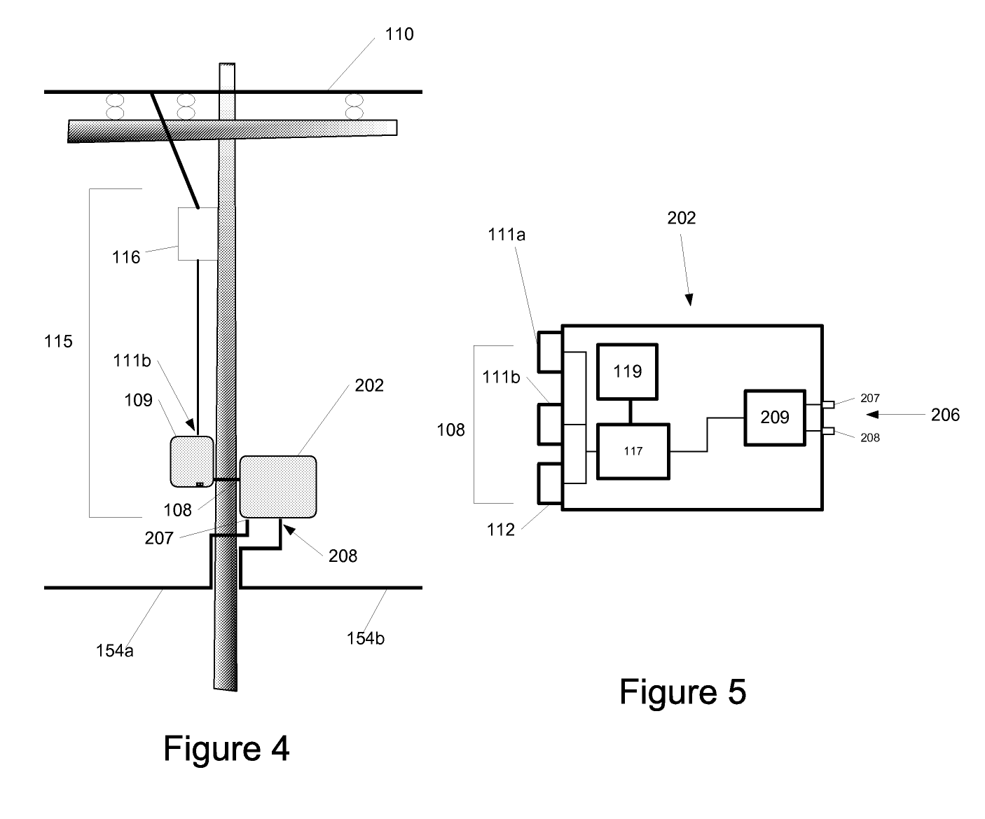

FIG. 4 illustrates the deployment of an alternate embodiment an interface device 202. In this embodiment, the interface device 202 is configured to communicate over a fiber optic conductor 154 (herein used interchangeably with fiber optic cable). The interface device 202 is also connected to, and is in communication with, one or more pieces of automated power distribution equipment 115. As with the interface device 102 of FIGS. 2 and 3, the automated power distribution equipment 115 of this example comprises a controller 109 and capacitor bank 116 (shown schematically in the figures). The interface device 202 enables communication between the fiber optic conductor 154 of the power line communication system 104 and the APDE 115 mounted on the pole. The automated power distribution equipment 115 may be connected to and powered by the LV power line (not shown in FIG. 4).

FIG. 5 illustrates the example embodiment of interface device 202. Like the embodiment of FIG. 3, the interface device 202 of FIG. 5 includes an equipment interface 108 that is configured to communicate with the automated power distribution equipment 115. The interface device 202 also includes a network interface 206 that is configured to communicate over the fiber optic cable 154.

The interface device 202 also may include a configuration port, a controller 117 and memory 119. The equipment interface 108, configuration port, controller 117, and memory 119 may include the components and functionality of the similarly identified products of FIG. 3 and therefore are not described again here.

In the present embodiment, the network interface 206 may include for example, a fiber optic data switch 209 (e.g., a Gig-E switch). Thus, the network interface 206 may provide Ethernet connectivity via a Gig-E-to-Ethernet first port 207 and second port 208, which are each communicatively coupled to switch 209. The gig-E switch 209 maintains a table of which communication devices are connected to which switch 209 port (e.g., based on MAC address). When a device transmits a data packet, the switch 209 receiving the packet determines the data packet's destination address and forwards the packet towards the destination device rather than to every device in a given network. This greatly increases the potential speed of the network because collisions are substantially reduced or eliminated, and multiple communications may occur simultaneously.

Referring to FIGS. 4 and 5, fiber port 207 may be connected to a first fiber conductor 154a that may be connected to an upstream device (e.g., an access node 134, backhaul node 132, or another interface device 202) and the second fiber port 208 may be connected to a second fiber conductor 154b that is connected to a downstream device (e.g., an access node 134 or another interface device 202). The communications from an upstream device are received at port 207 via the fiber optic conductor 154a by switch 209 and may (if the data packet is addressed appropriately) passed (by switch 209) to the controller 117 for communication to the APDE 115 or to port 208 for communication to a downstream device. Upstream communications from a downstream device may be received at port 208 via the fiber optic conductor 154b by switch 209 and may (if the data packet is addressed appropriately) passed (by switch 209) to the controller 117 for communication to the APDE 115 or to port 208 for communication to the upstream device. The switch 209 also acts to communicate data received at the equipment interface 108 and provided to the switch 209 by the controller 117 to the upstream port 207. Thus, switch 209 may act as a conventional data packet switch (or router or bridge). The interface device 202 (or 102) may also include a battery backup that powers the interface device 202 should the power to the LV power line be interrupted. As discussed below, the switch 209 (which may include substantially the same functionality of as the switch used in the backhaul device or access device) may be configured to allow data to pass through the interface device 202 without being provided to the controller 117 (unless the data packet is addressed to the device 202).

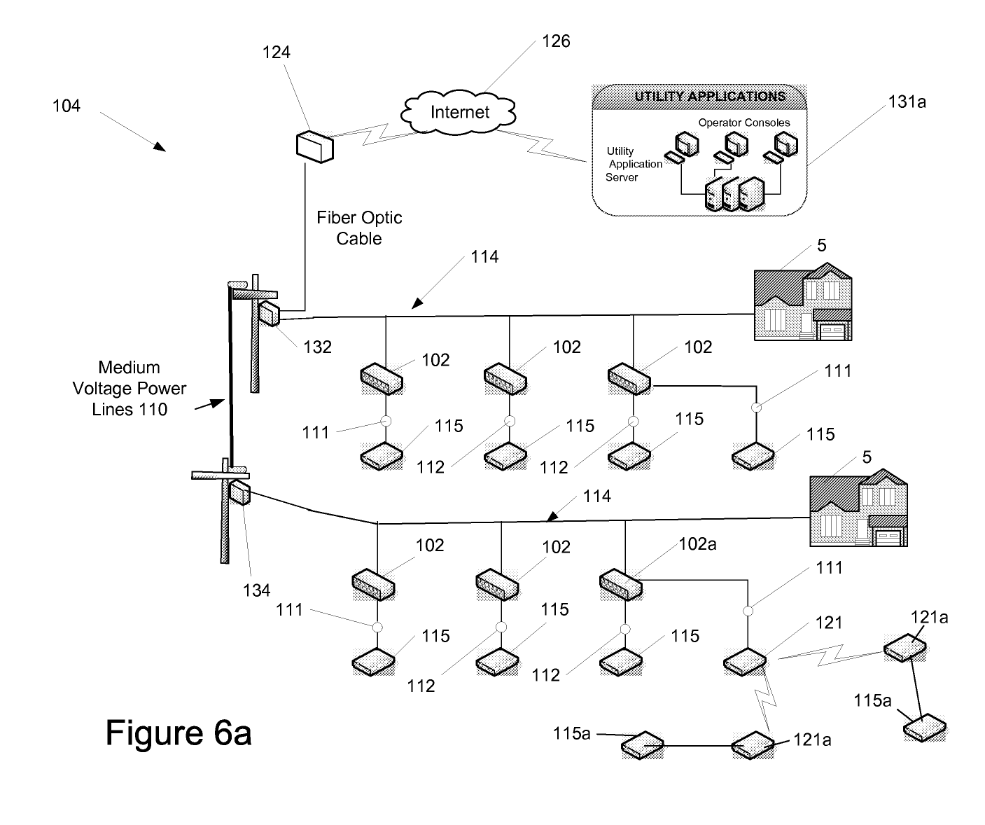

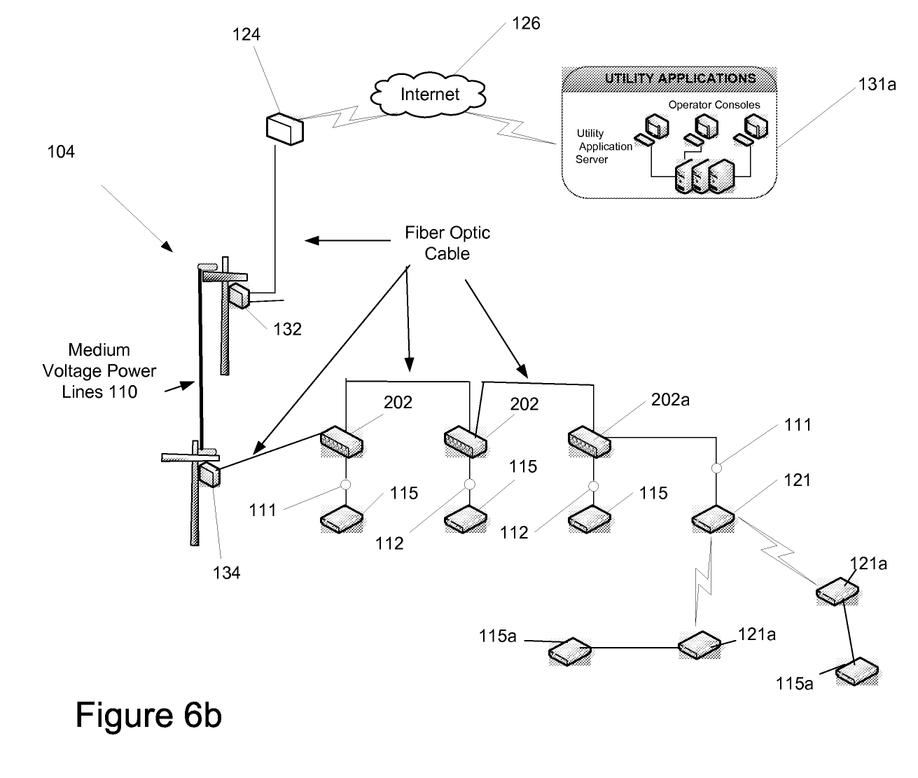

FIGS. 6a and 6b provide architectural overviews of the interface device of FIG. 3 and FIG. 5, respectively. In these example embodiments, the communication system 104 provides communications to a plurality of automated power distribution equipment 115. The communication system 104 includes a computer system 131a that includes executable program code. The executable program code is executable to generate control messages for controlling the plurality of automated power distribution equipment 115 (individually and simultaneously). The computer system may also include a database storing the address and configuration information of all or some of the automation equipment 115.

In the example of FIG. 6a, the power line communication system provides a plurality of interface devices 102, where each interface device 102 is configured to communicate with one or more of the plurality of automated power distribution equipment 115. The computer system 131a is configured to transmit the control messages to the plurality of automated power distribution equipment 115 via the power line communication network 104 and the plurality of interface devices 102.

In this example embodiment, data from the computer system 131a may traverse the internet 126, to an aggregation point 124, over fiber (or wirelessly) to a backhaul node 132, over one or more MV power lines 110, and to an access node 134. Data from the access node 134 and/or backhaul node 132 may be transmitted (via unicast, broadcast, or multi-cast transmission) over one or more LV power lines 114 to one or more interface devices 102. Each interface device may then selectively transmit the data to one or more of its automated power distribution equipment 115.

In addition, an interface device 102a may be coupled to a radio transceiver 121 via a serial port 111 (or alternately via an Ethernet port) where the transceiver 121 is configured to wirelessly communicate with one or more other radio transceivers 121a, each of which may be communicatively coupled to automated power distribution equipment 115a. In other embodiments, the radio transceiver 121 may be integrated into the interface device 102.

As shown in the figure, the power line communication devices 134 and 132 may also provide communications to user devices (130) that are in one or more customer premises 5 that may also be connected to the LV power line 114. Thus, in this example embodiment system 104 is configured to communicate broadband data signals over one or more power lines 114 provide broadband Internet access to a plurality of consumers while also communicating utility data.

In the example of FIG. 6b, the power line communication system provides a plurality of interface devices 202, where each interface device 202 is configured to communicate with one or more of the plurality of automated power distribution equipment 115. The computer system 131a is configured to transmit the control messages to the plurality of automated power distribution equipment 115 via the power line communication network 104 and the plurality of interface devices 202.

In this example embodiment, data from the computer system 131a may traverse the internet 126, to an aggregation point 124, over fiber (or wirelessly) to a backhaul node 132, over one or more MV power lines 110, and to an access node 134. Data from the access node 134 and/or backhaul node 132 may be transmitted (via unicast, broadcast, or multi-cast transmission) over a fiber optic cable to one or more interface devices 202. Each interface device 202 may then selectively transmit the data to one or more of its automated power distribution equipment 115 or a downstream interface device 202 (which may be connected to each other in daisy chain fashion via their ports 207 and 208).

In addition, an interface device 202a may be coupled to a radio transceiver 121 via a serial port 111 (or alternately via an Ethernet port) where the transceiver 121 is configured to wirelessly communicate with one or more other radio transceivers 121a, each of which may be communicatively coupled to automated power distribution equipment 115a. In other embodiments, the radio transceiver 121 may be integrated into the interface device 202.

The power line communication devices 134 and 132 may also provide communications to user devices (130) that are in one or more customer premises that may also be connected to the LV power line 114 (not shown in FIG. 6b). Thus, in this example embodiment system 104 is configured to communicate broadband data signals over one or more power lines 114 or fiber optic conductors to provide broadband Internet access to a plurality of consumers while also communicating utility data. In still another embodiment, the interface device 202 may be coupled directly to the aggregation point 124 or the backhaul node 138 via fiber optic cable in which cases the data communicated to and from the interface device may not traverse a power line.

Thus, communication system 104 may enable a user of a computer system 131a to transmit data to, receive data from, and remotely control one or a plurality of power transmission automation equipment 115 (i.e., the controller 109 thereof), which may be individually addressed (e.g., a MAC and/or IP address). Address information may be transmitted to and stored in the computer system 131 a from the interface device 102/202 after the device 102/202 is provisioned onto the network (as described above).

Backhaul Node 132:

Other communication nodes, such as access nodes, repeaters, and other backhaul nodes, may communicate to and from the IP network via a backhaul node 132. In one example embodiment, a backhaul node 132 comprises a backhaul device 138. The backhaul device 138, for example, may transmit communications directly to an aggregation point 124, or to a distribution point 127 which in turn transmits the data to an aggregation point 124.

FIGS. 7 and 8 illustrates an example embodiment of a backhaul device 138 which may form all or part of a backhaul node 132. The backhaul device 138 may include a medium voltage power line interface (MV Interface) 140, a controller 142, an expansion port 146, and a gigabit Ethernet (gig-E) switch 148. In some embodiments the backhaul device 138 also may include a low voltage power line interface (LV interface) 144. The MV interface 140 is used to communicate over the MV power lines and may include an MV power line coupler coupled to an MV signal conditioner, which may be coupled to an MV modem 141. The MV power line coupler prevents the medium voltage power from passing from the MV power line 110 to the rest of the device's circuitry, while allowing the communications signal to pass between the backhaul device 138 and the MV power line 110. The MV signal conditioner may provide amplification, filtering, frequency translation, and transient voltage protection of data signals communicated via the MV power lines 110. Thus, the MV signal conditioner may be formed by a filter, amplifier, a mixer and local oscillator, and other circuits which provide transient voltage protection. The MV modem 141 may demodulate, decrypt, and decode data signals received from the MV signal conditioner and may encode, encrypt, and modulate data signals to be provided to the MV signal conditioner.

The backhaul device 138 also may include a low voltage power line interface (LV Interface) 144 for receiving and transmitting data over an LV power line 114. The LV interface 144 may include an LV power line coupler coupled to an LV signal conditioner, which may be coupled to an LV modem 143. In one embodiment the LV power line coupler may be an inductive coupler. In another embodiment the LV power line coupler may be a conductive coupler or capacitive coupler. The LV signal conditioner may provide amplification, filtering, frequency translation, and transient voltage protection of data signals communicated via the LV power lines 114. Data signals received by the LV signal conditioner may be provided to the LV modem 143. Thus, data signals from the LV modem 143 are transmitted over the LV power lines 110 through the signal conditioner and LV coupler. The LV signal conditioner may be formed by a filter, amplifier, a mixer and local oscillator, and other circuits which provide transient voltage protection. The LV modem 143 may demodulate, decrypt, and decode data signals received from the LV signal conditioner and may encode, encrypt, and modulate data signals to be provided to the LV signal conditioner.

The backhaul device 138 also may include an expansion port 146, which may be used to connect to a variety of devices. For example a wireless access point, which may include a wireless transceiver or modem 147, may be integral to or coupled to the backhaul device 138 via the expansion port 146. The wireless modem 147 may establish and maintain a wireless communication link 150. In other embodiments a communication link is established and maintained over an alternative communications medium (e.g., fiber optic, cable, twisted pair) using an alternative transceiver device. In such other embodiments the expansion port 146 may provide an Ethernet connection allowing communications with various devices over optical fiber, coaxial cable or other wired medium. In such embodiment the modem 147 may be an Ethernet transceiver (fiber or copper) or other suitable modem may be employed (e.g., cable modem, DSL modem). In other embodiments, the expansion port 146 may be coupled to a Wifi access point (IEEE 802.11 transceiver), WiMAX (IEEE 802.16), or mobile telephone cell site. The expansion port 146 may be employed to establish a communication link 150 between the backhaul device 138 and devices at a residence, building, other structure, another fixed location, or between the backhaul device 138 and a mobile device. Alternately, various sensors also may be connected to the backhaul device 138 through the expansion port 146. Exemplary sensing devices that may be coupled to the backhaul device 138 through the expansion port 146 include a current sensor, power usage sensing device, a level sensor (to determine pole tilt), a camera (e.g., for monitoring security, detecting motion, monitoring children's areas, monitoring a pet area), an audio input device (e.g., microphone for monitoring children, detecting noises), a vibration sensor, a motion sensor (e.g., an infrared motion sensor for security), a home security system, a smoke detector, a heat detector, a carbon monoxide detector, a natural gas detector, a thermometer, a barometer, a biohazard detector, a water or moisture sensor, a temperature sensor, and a light sensor. The expansion port may provide direct access to the core processor (which may form part of the controller 142) through a MII (Media Independent Interface), parallel, serial, or other connection. This direct processor interface may then be used to provide processing services and control to devices connected via the expansion port 256 thereby allowing connection of a less expensive device (e.g., sensor).

The backhaul device 138 also may include a gigabit Ethernet (Gig-E) switch 148. Gigabit Ethernet is a term describing various technologies for implementing Ethernet networking at a nominal speed of one gigabit per second, as defined by the IEEE 802.3z and 802.3ab standards. There are a number of different physical layer standards for implementing gigabit Ethernet using optical fiber, twisted pair cable, or balanced copper cable. In 2002, the IEEE ratified a 10 Gigabit Ethernet standard which provides data rates at 10 gigabits per second. The 10 gigabit Ethernet standard encompasses seven different media types for LAN, MAN and WAN. Accordingly the gig-E switch may be rated at 1 gigabit per second (or greater as for a 10 gigabit Ethernet switch).

The switch 148 may be included in the same housing or co-located with the other components of the node (e.g., mounted at or near the same utility pole or transformer). The gig-E switch 148 maintains a table of which communication devices are connected to which switch 148 port (e.g., based on MAC address). When a communication device transmits a data packet, the switch receiving the packet determines the data packet's destination address and forwards the packet towards the destination device rather than to every device in a given network. This greatly increases the potential speed of the network because collisions are substantially reduced or eliminated, and multiple communications may occur simultaneously.

The gig-E switch 148 may include an upstream port for maintaining a communication link 152 with an upstream device (e.g., a backhaul node 132, an aggregation point 124, a distribution point 127), a downstream port for maintaining a communication link 152 with a downstream device (e.g., another backhaul node 134; an access node 134), and a local port for maintaining a communication link 154 to a Gig-E compatible device such as a mobile telephone cell cite 155 (i.e., base station), a wireless device (e.g., WiMAX (IEEE 802.16) transceiver), an access node 134, another backhaul node 132, or another device. In some embodiments the gig-E switch 148 may include additional ports. The Gig-E switch 148 (via local link 154, or downstream link 154), expansion port 146, and/or LV Interface 144 may be coupled to one or more interface devices 102/202 for providing communications to and from one or more pieces of automated power distribution equipment 115.

In one embodiment, the local link 154 may be connected to mobile telephone cell site configured to provide mobile telephone communications (digital or analog) and use the signal set and frequency bands suitable to communicate with mobile phones, PDAs, and other devices configured to communicate over a mobile telephone network. Mobile telephone cell sites, networks and mobile telephone communications of such mobile telephone cell sites, as used herein, are meant to include analog and digital cellular telephone cell sites, networks and communications, respectively, including, but not limited to AMPS, 1G, 2G, 3G, GSM (Global System for Mobile communications), PCS (Personal Communication Services) (sometimes referred to as digital cellular networks), 1x Evolution-Data Optimized (EVDO), and other cellular telephone cell sites and networks. One or more of these networks and cell sites may use various access technologies such as frequency division multiple access (FDMA), time division multiple access (TDMA), or code division multiple access (CDMA) (e.g., some of which may be used by 2G devices) and others may use CDMA2000 (based on 2G Code Division Multiple Access), WCDMA (UMTS)—Wideband Code Division Multiple Access, or TD-SCDMA (e.g., some of which may be used by 3G devices).

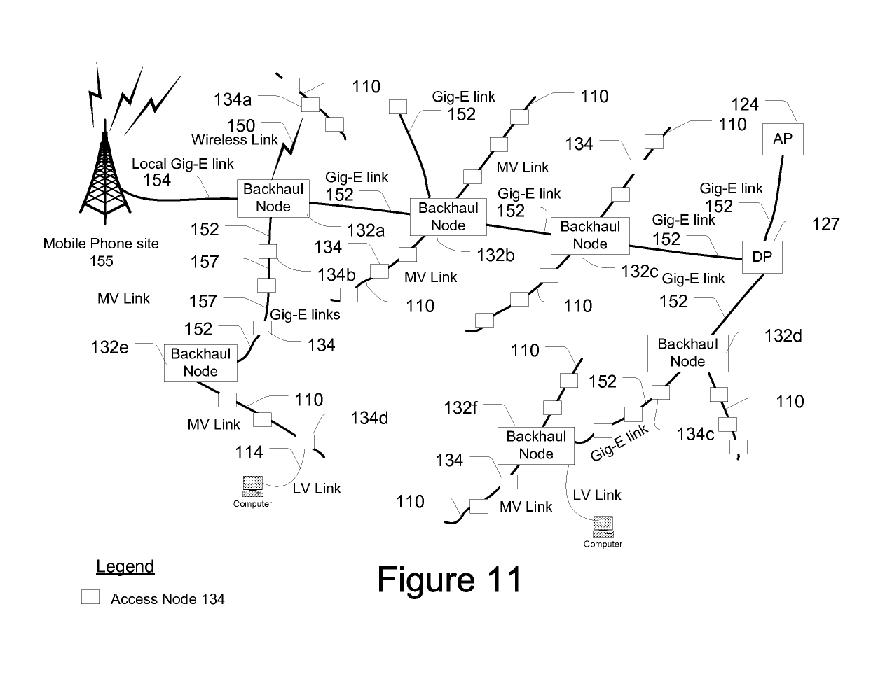

The gig-E switch 148 adds significant versatility to the backhaul device 138. For example, several backhaul devices may be coupled in a daisy chain topology (see FIG. 11), rather than by running a different fiber optic conductor to each backhaul node 134. Additionally, the local gig-E port allows a communication link 154 for connecting to high bandwidth devices (e.g., WiMAX (IEEE 802.16) or other wireless devices). The local gig-E port may maintain an Ethernet connection for communicating with various devices over optical fiber, coaxial cable or other wired medium. Exemplary devices may include user devices 130, a mobile telephone cell cite 155, and sensors (as described above with regard to the expansion port 146).

Communications may be input to the gig-E switch 148 from the MV interface 140, LV interface 144 or expansion port 146 (via the controller 142). Communications also may be received at the switch 148 from each of the upstream port, local port and downstream port. The gig-E switch 148 may be configured (by the controller 142 dynamically) to direct the data received from a given input port through the switch 148 to the upstream port, local port, or downstream port as desired. An advantage of the gig-E switch 148 is that communications received at the upstream port or downstream port need not be provided (if so desired) to the controller 142. Specifically, communications received at the upstream port or downstream port need not be buffered or otherwise stored in the controller memory or processed by the controller 142. (Note, however, that communications received at the local port may be directed to the controller 142 for processing or for output over the MV interface 140, LV interface 144 or expansion port 146). The controller 142 controls the gig-E switch 148, allowing the switch 148 to pass data upstream and downstream (e.g. according to parameters (e.g., prioritization, rate limiting, etc.) provided by the controller). In particular, data may pass directly from the upstream port to the downstream port without the controller 142 receiving the data. Likewise, data may pass directly from the downstream port to the upstream port without the controller 142 receiving the data. Also, data may pass directly from the upstream port to the local port in a similar manner; or from the downstream port to the local port; or from the local port to the upstream port or downstream port. Moving such data through the controller 142 would significantly slow communications or require an ultra fast processor in the controller 142. Data from the controller 142 (originating from the controller 142 or received via the MV interface 140, the LV interface 144, or expansion port 146) may be supplied to the Gig-E switch 148 for communication upstream (or downstream) via the upstream port (or downstream port) according to the address of the data packet. Thus, data from the controller 142 may be multiplexed in (and routed/switched) along with other data communicated by the switch 148. As used herein, to route and routing is meant to include the functions performed by of any a router, switch, and bridge.

The backhaul device 138 also may include a controller 142 which controls the operation of the device 138. The backhaul device 138 also may include a router, which routes data along an appropriate path. In this example embodiment, the controller 142 includes program code for performing routing (hereinafter to include switching and/or bridging). Thus, the controller 142 may maintain a table of which communication devices are connected to each port in memory. The controller 142, of this embodiment, matches data packets with specific messages (e.g., control messages) and destinations, performs traffic control functions, performs usage tracking functions, authorizing functions, throughput control functions and similar related services. Communications entering the backhaul device 138 from the MV power lines 110 at the MV interface 140 are received, and then may be routed to the LV interface 144, expansion port 146 or gig-E switch 148. Communications entering the backhaul device 138 from the LV power lines 114 at the LV interface 144 are received, and may then be routed to the MV interface 140, the expansion port 146, or the gig-E switch 148. Communications entering the backhaul point 138 from the expansion port 146 are received, and may then be routed to the MV interface 140, the LV interface 144, or the gig-E switch 148. Accordingly, the controller 142 may receive data from the MV interface 140, LV interface 144 or the expansion port 146, and may route the received data to the MV interface 140, LV interface 144, the expansion port 146, or gig-E switch 148. In this example embodiment, user data may be routed based on the destination address of the packet (e.g., the IP destination address). Not all data packets, of course, are routed. Some packets received may not have a destination address for which the particular backhaul device 138 routes data packets (and may be discarded). Additionally, some data packets may be addressed to the backhaul device 138 itself, in which case the backhaul device 138 may process the data as a control message.

Access Node 134:

The backhaul nodes 132 may communicate with user devices via one or more access nodes 134, which may include an access device 139. FIGS. 9-10 show an example embodiment of such an access device 139 for providing communication services to mobile devices and to user devices at a residence, building, and other locations.

In one example embodiment, access nodes 134 provide communication services for user devices 130 such as security management; IP network protocol (IP) packet routing; data filtering; access control; service level monitoring; service level management; signal processing; and modulation/demodulation of signals transmitted over the communication medium.

The access device 139 of this node 134 may include a bypass device that moves data between an MV power line 110 and an LV power line 114. The access device 139 may include a medium voltage power line interface (MV Interface) 140 having a MV modem 141, a controller 142, a low voltage power line interface (LV interface) 144 having a LV modem 143, and an expansion port 146, all of which may have the functionality and functional components (e.g., for connecting to other devices) as previously described above with regard to FIG. 7 of the backhaul device 138. The access device 139 also may include a gigabit Ethernet (gig-E) port 156. The gig-E port 156 maintains a connection using a gigabit Ethernet protocol as described above for the gig-E switch 148 of FIG. 7.

The Gig-E port 156 may maintain an Ethernet connection for communicating with various devices over optical fiber, coaxial cable or other wired medium. For example, a communication link 157 may be maintained between the access device 139 and another device through the gig-E port 156. For example, the gig-E port 156 may provide a connection to user devices 130, sensors (as described above with regard to the expansion port 146), or a cell station 155. The Gig-E port 156, expansion port 146, and/or LV Interface 144 may be coupled to one or more interface devices 102/202 for providing communications to and from one or more pieces of automated power distribution equipment 115.

Communications may be received at the access device 139 through the MV interface 140, LV interface 144, expansion port 146 or gig-E port 156. Communications may enter the access device 139 from the MV power lines 110 through the MV interface 140, and then may be routed to the LV interface 142, expansion port 146 or gig-E port 156. Communications may enter the access device 139 from the LV power lines 114 through the LV interface 144, and then may be routed to the MV interface 140, the expansion port 146, or the gig-E port 156. Communications may enter the access device 139 from the expansion port 146, and then may routed to the MV interface 140, the LV interface 144, or the gig-E port 156. Communications may enter the access device 139 via the gig-E port 156, and then may be routed to the MV interface 140, the LV interface 144, or the expansion port 146. The controller 142 controls communications through the access device 139. Accordingly, the access device 139 receives data from the MV interface 140, LV interface 144, the expansion port 146, or the gig-E port 156 and may route the data to the MV interface 140, LV interface 144, expansion port 146, or gig-E port 156 under the direction of the controller 142. In one example embodiment, the access node 134 may be coupled to a backhaul node 132 via a wired medium coupled to Gig-E port 156 while in another embodiment, the access node is coupled to the backhaul node 132 via an MV power line (via MV interface 140). In yet another embodiment, the access node 134 may be coupled to a backhaul node 132 via a wireless link (via expansion port 146 or Gig-E port 156).

Software

The communication network 104 may be monitored and controlled via a power line server (PLS) that may be remote from the structure and physical location of the network elements. The controller of the nodes 128 describe herein may include executable program code for controlling the operation of the nodes and responding to commands. The PLS may transmit any number of commands to a backhaul nodes 132 and access nodes 134 to manage the system. As will be evident to those skilled in the art, most of these commands are equally applicable for backhaul nodes 132 and access nodes 134. For ease of discussion, the description of the commands will be in the context of a node 128 (meant to include both). These commands may include altering configuration information, synchronizing the time of the node 128 with that of the PLS, controlling measurement intervals (e.g., voltage measurements), requesting measurement or data statistics, requesting the status of user device activations, rate shaping, and requesting reset or other system-level commands. Any or all of these commands may require a unique response from the node 128, which may be transmitted by the node 128 and received and stored by the PLS. The PLS may include software to transmit a command to any or all of the nodes (134 and 132) to schedule a voltage and/or current measurement at any particular time so that all of the network elements of the PLCS take the measurement(s) at the same time.

Alerts

In addition to commands and responses, the node 128 has the ability to send Alerts and Alarms to the PLS. Alerts typically are either warnings or informational messages transmitted to the PLS in light of events detected or measured by the node 128. Alarms typically are error conditions detected.

One example of an Alarm is an Out-of-Limit Alarm that indicates that an out-of-limit condition has been detected at the node 128, which may indicate a power outage on the LV power line, an MV or LV voltage too high, an MV or LV voltage too low, a temperature measurement inside the node 128 is too high, and/or other out-of-limit conditions. Information of the Out-of-Limit condition, such as the type of condition (e.g., a LV voltage measurement, a node 128 temperature), the Out-of-Limit threshold exceeded, the time of detection, the amount (e.g., over, under, etc.) the out of limit threshold has been exceeded, is stored in the memory of the node 128 and transmitted with the alert or transmitted in response to a request from the PLS.

Software Upgrade Handler

The Software Upgrade Handler software may be started by the node 128 Command Processing software in response to a PLS command. Information needed to download the upgrade file, including for example the remote file name and PLS IP address, may be included in the parameters passed to the Software Command Handler within the PLS command.

Upon startup, the Software Command Handler task may open a file transfer program such as Trivial File Transfer Protocol (TFTP) to provide a connection to the PLS and request the file. The requested file may then be downloaded to the node 128. For example, the PLS may transmit the upgrade through the Internet to the node 128 (and perhaps through the backhaul node, and over the MV power line) where the upgrade may be stored in a local RAM buffer and validated (e.g., error checked) while the node 128 continues to operate (i.e., continues to communicate packets). Finally, the task copies the downloaded software into a backup boot page in non-volatile memory, and transmits an Alert indicating successful installation to the PLS. The node 128 then makes the downloaded software the primary boot page and reboots. When the device restarts the downloaded software will be copied to RAM and executed. The device will then notify the PLS that it has rebooted via an alert indicating such. In addition, and through substantially the same procedure, new software code may be received by the controller for storage in (e.g., to replace existing code) and execution at the media access control (MAC) layer of the LV modem and/or the MV modem of the access device or the backhaul device.

ADC Scheduler

Any of the nodes described herein may include an analog to digital converter (ADC) for measuring the voltage and/or current of any power line. The ADC Scheduler software, in conjunction with the real-time operating system, creates ADC scheduler tasks to perform ADC sampling according to configurable periods for each sample type. Each sample type corresponds with an ADC channel. The ADC Scheduler software creates a scheduling table in memory with entries for each sampling channel according to default configurations or commands received from the PLS. The table contains timer intervals for the next sample for each ADC channel, which are monitored by the ADC scheduler.

ADC Measurement Software

The ADC Measurement Software, in conjunction with the real-time operating system, creates ADC measurement tasks that are responsible for monitoring and measuring data accessible through the ADC 330. Each separate measurable parameter may have an ADC measurement task. Each ADC measurement task may have configurable rates for processing, recording, and reporting for example.

An ADC measurement task may wait on a timer (set by the ADC scheduler). When the timer expires the task may retrieve all new ADC samples for that measurement type from the sample buffer, which may be one or more samples. The raw samples are converted into a measurement value. The measurement is given the timestamp of the last ADC sample used to make the measurement. The measurement may require further processing. If the measurement (or processed measurement) exceeds limit values, an alert condition may be generated. Out of limit Alerts may be transmitted to the PLS and repeated at the report rate until the measurement is back within limits. An out of limit recovery Alert may be generated (and transmitted to the PLS) when the out of limit condition is cleared (i.e., the measured value falls back within limit conditions).

The measurements performed by the ADC, each of which has a corresponding ADC measurement task, may include node 128 inside temperature, LV power line voltage, LV power line current (e.g., the voltage across a resistor), MV power line voltage, and/or MV power line current for example. MV power line measurements may be accomplished via a separate power line coupler, which may be an inductive coupler.

As discussed, the nodes may include value limits for most of these measurements stored in memory with which the measured value may be compared. If a measurement is below a lower limit or above an upper limit (or otherwise out of an acceptable range), the node 128 may transmit an Out-of-Limit Alert, which is received and stored by the PLS. In some instances, one or more measured values are processed to convert the measured value(s) to a standard or more conventional data value.

The LV power line voltage measurement may be used to provide various information. For example, the measurement may be used to determine a power outage (and subsequently a restoration), or measure the power used by a consumer or by all of the consumers connected to that distribution transformer. In addition, it may be used to determine the power quality of the LV power line by measuring and processing the measured values over time to provide frequency, harmonic content, and other power line quality characteristics.

Traffic Monitoring Software

The Traffic Monitoring software may collect various data packet traffic statistics, which may be stored in memory including the amount of data (i.e., packets and/or bytes) communicated (i.e., transmitted and received) through the MV power line, through the switch, and/or through the LV power line; the amount of data (packets and/or bytes) communicated (transmitted and received) to or from the PLS; the number of Alerts and Alarms sent to the PLS; the number of DHCP messages to or from user devices; the number of failed user device authentications; the number of failed PLS authentications; and the number of packets and bytes received and/or transmitted from/to each user device (or PLM 50).

Rate Limiting

The nodes may include software for monitoring the bit rate of a particular device (e.g., PLM, computer, television, stereo, telephone, fax, gaming device, etc.) and also for rate limiting the communications of the device. Thus, if the bit rate (i.e., number of bits communicated over a given time period) reaches a particular threshold value for the device (which may be stored in memory of the node 128), the node 128 may slow or stop (postpone) communications for that device (e.g., until the beginning of the next time period, which may be one or more seconds, milliseconds, minutes, or microseconds). The threshold value may be received from the PLS during initial configuration, after configuration, upon request by the user, or after a modification of the user's subscription level.

For example, a user may transmit a request to rate limit a particular device to the PLS, which would allow a parent to rate limit the communications of a child's gaming device (e.g., Xbox™, or Playstation™), the child's downloading of music or video, Voice of Internet Protocol (VoIP), peer to peer communications (e.g., often used to transfer MP3 music files), or the communication of video or image files. In response, the PLS may transmit a rate limiting command and information to the node 128 to activate rate limiting of the device or process, which thereby initiates rate limiting in response to the PLS command. Thus, rate limiting may be effected for only select devices or processes of the subscriber, which may be requested by the user. As an example, a parent could turn off, turn on, or limit VoIP at certain times of the day or days of the week.

The rate limit information transmitted to the node 128 may include information of the device (e.g., address) and/or process (e.g., which may be indicated by the type of packets communicated such as video, gaming, voice, computer, MP3) that are to be rate limited for that subscriber or device. Thus, the node 128 may include information in memory sufficient to recognize certain types of processes (or packets), which is compared to communicated data to determine if rate limiting should be performed. Similarly, if rate limiting is based on address information (e.g., of the source and/or destination device), the node 128 may include rate limiting address information in memory, which is compared to address information of the communicated data to determine whether rate limiting should be performed. The rate limit information may also include a first threshold value for upstream and a second threshold value for downstream communications, which may or may not be the same.

In one embodiment the home administrator may “setup” all the home users (and their limits) and the information may be stored in memory at the node 128. When a home user logs in, their rule base will be attached to the virtual interface created by the login to perform the rate limiting. In a second embodiment, the home administrator may “setup” all the home users (and their limits) and the information may be stored in memory on a server at the POP. When a home user logs in, their rule base will be attached to the virtual interface created by the login to perform the rate limiting. In a third embodiment, the home administrator may “setup” all the home users (and their limits) and the information may be stored in memory on a server at the POP. When a home user logs in, their rule base will be attached to the virtual interface created by the login. The server will transmit a command and data to dynamically add or remove filter and rate limit rules to the node 128, which will store the data in memory and filter and/or rate limit according to the received information. Rate limiting may implementing via Extensible Authentication Protocol (EAP), Point-to-Point Protocol Over Ethernet (PPPoE), or virtual private network (VPN).

The rate limiting software in the node 128 (or remote POP server) may analyze the data packets and may limit the communication of data packets through the node 128 based on data packets:1) that are transmitted to the user device from a particular source (e.g., from a particular person, PLM, modem, user, domain name, email address, IP address and/or MAC source address); 2) that are transmitted from the user device to a particular destination (e.g., to a particular person, email address, user, domain name, modem, IP address and/or MAC destination address); 3) that have particular content (e.g., voice data, gaming data, image, audio, and/or video data); 4) based on the time of transmission or reception (e.g., times of the day and/or day(s) of the week); 5) that surpass a threshold quantity of data (either transmitted, received, or combination thereof) for a predetermined window of time (e.g., hour, minute, second, day, week, month, year, or subscription period); and/or 6) some combination thereof.

The rate limiting function may be used to rate limit or completely stop any or all such transmissions described above according any of such conditions. As an example of an application of rate limiting, the user may limit a particular device (e.g., a VoIP telephone) or data (VoIP data) to zero bits per second (bps) (i.e., prevent telephone calls) from 3 PM to 7 PM on Monday through Friday. Alternately, the user may limit gaming data to 1 Mbps from between 7 PM to 9 PM and allow the default rate (e.g., the rate provided to the user via the user's subscription which may also be controlled by the rate limiting function) during other times.

The nodes may also implement quality of service (QoS) for packets to and from certain devices, as a means to rate limit or in addition to rate limiting. For example, data of live voice communications (e.g., telephone voice communications) may be given higher priority than video data, which may be given higher priority than, gaming data, and computer data. Software on the user device may also add tags (bits) to the data packets to allow the node 128 to recognize the type of packet for implementing QoS, rate limiting, and data filtering. Thus, the nodes may receive the QoS information via the power line or other medium from the PLS for a particular subscriber, device, or process, and store the information in memory. Subsequently, the PLS may change the QoS setting in response to a user request or a change in the user's subscription—as instructed by the PLS. For example, when the user transmits a request to upgrade his or her subscription from data to voice (telephone) and data, the PLS may transmit new QoS information to the node 128 so that voice data of the user is given higher priority for transmission.

Data Filtering Software

The Data Filtering software provides filtering of data packets transmitted to and/or from a user device (or PLM 50). The filtering criteria may be supplied from the PLS (which may be based on requests received from the user) and is stored in memory of the node 128 and may form part of the routing table. The Data Filtering software may analyze the data packets and may prevent the transmission of data packets through the node 128: 1) that are transmitted to the user device from a particular source (e.g., from a particular person, user, domain name, email address, or IP or MAC source address); 2) that are transmitted from the user device to a particular destination (e.g., to a particular person, email address, user, domain name, or IP or MAC destination address); 3) that have particular content (e.g., voice data or video data); 4) based on the time of transmission or reception (e.g., times of the day and/or days of the week); 5) that surpass a threshold quantity of data (either transmitted, received, or combination thereof) for a predetermined window of time (e.g., a day, week, month, year, or subscription period); or 7) some combination thereof.

Examples of other access devices 139, backhaul points 138, repeaters 158, power line servers, and other components are provided in U.S. patent application Ser. No. 11/091,677 filed Mar. 28, 2005, entitled “Power Line Repeater System and Method,” which is hereby incorporated by reference in its entirety. A detailed description of another example PLCS, its components and features is provided in U.S. patent application Ser. No. 10/973,493 filed Oct. 26, 2004, entitled “Power Line Communications System and Method of Operating the Same,” which is hereby incorporated by reference in its entirety.

FIG. 11 shows an example embodiment of a network topology which illustrates many of the communication features of the backhaul node 132 and access node 134. For example, several backhaul nodes 132a-c may be coupled together in a daisy chain configuration by fiber communication links 152. Such links 152 may be formed by the upstream and downstream ports of the gig-E switch 148 of the respective backhaul nodes 132. The gig-E switch 148 also may be implemented to connect a backhaul node 132c to a distribution point 127. Accordingly, the gig-E switch 148 may form part of a communication link along a path for communicating with an internet protocol network 126. Further, a local port of a gig-E switch 148 may be implemented to couple a backhaul node 132a to a mobile phone cell site 155 via link 154. The backhaul nodes 132a-d also may be coupled to MV power lines 110 to maintain MV communication links with multiple access nodes 134 (shown as small rectangles). The backhaul node 132a may also be coupled to an access node 134a (which may repeat data for other access nodes 134) via a wireless communication link 150, for example, through their respective expansion ports 146. The backhaul node 132a may further be coupled to a chain of access devices 134 and a backhaul node 132e. The link from the backhaul node 132a to the access node 134b may be formed by coupling a downstream port of the gig-e switch 148 of backhaul node 132a to the gig-E port 156 of the access node 134b. A similar link is shown between the backhaul node 132d and the access node 134c. Still another communication link is shown over an LV power line 114 to couple an access node 134d to a computer and to couple a backhaul node 132f to computer via a LV power line 114.

Other Devices:

Another communication device is a repeater (e.g., indoor, outdoor, low voltage (LVR) and/or medium voltage) which may form part of a repeater node 135. A repeater serves to extend the communication range of other communication elements (e.g., access devices, backhaul points, and other nodes). The repeater may be coupled to power lines (e.g., MV power line; LV power line) and other communication media (e.g., fiber optical cable, coaxial cable, T-1 line or wireless medium). Note that in some embodiments, a repeater node 135 may also include a device for providing a link to a user device 130 (and thus also serve as an access node 134).

In various embodiments a user device 130 is coupled to an access node 134 using a modem. For a power line medium, a power line modem 136 is used. For a wireless medium, a wireless modem is used. For a coaxial cable, a cable modem is may be used. For a twisted pair, a DSL modem may be used. The specific type of modem depends on the type of medium linking the access node 134 and user device 130.

A power line modem 136 couples a communication onto or off of an LV power line 114. A power line modem 136 is coupled on one side to the LV power line. On the other side, the power line modem 136 includes a connector to connect to a wired or wireless medium leading to the user device 130. One protocol for communicating with access nodes 132 over an LV power line is the HomePlug 1.0 standard of the HomePlug® Alliance for routing communications over low voltage power lines. In this manner, a customer can connect a variety of user devices 130 to the communication network 104.

Other embodiments of the interface device 102/202 of the present invention may be used to interface other devices (other than automated power distribution equipment) to a PLCS. For example, various embodiments of the present invention may be used to connect a PLCS to a traffic light, an electronic bill board, a traffic light controller, or other device to allow such devices to be remotely controlled or provide data. In addition, the interface device described here may also be employed to interface devices to underground broadband over power line communication systems. In another embodiment, the interface device 102/202 may include routing tables for providing communications for other interfaces devices 102/202. Such an embodiment of the device 102/202 may be used to repeat data for other interface devices 102/202 and such communication links may be wireless, over a power line, or via fiber optic cable.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. An interface device for interfacing power distribution equipment to a broadband over power line communication system that provides broadband communications to one or more users, comprising:
a network interface configured to communicate via the broadband over power line communication system;
an equipment interface configured to communicate with at least one piece of power distribution equipment; and
a controller in communication with said equipment interface and said network interface.

2. The device of claim 1, wherein said controller is configured to control the flow of data to the power distribution equipment.

3. The device of claim 1, wherein said equipment interface is configured to communicate with a plurality of power distribution equipment.

4. The device of claim 1, wherein the at least one piece of power distribution equipment includes an equipment controller configured to receive and process control messages received from said equipment interface.

5. The device of claim 1, wherein said network interface includes a first fiber optic port.

6. The device of claim 5, wherein said network interface further includes a second fiber optic port and a data switch communicatively coupled to said first and second fiber optic ports.

7. The device of claim 6, wherein said data switch is communicatively coupled to said controller.

8. The device of claim 1, wherein said network interface is configured to communicate via a low voltage power line.

9. The device of claim 1, further comprising a wireless transceiver communication coupled to said controller.

10. The device of claim 1, wherein said equipment interface communicates with the power distribution equipment via a path that includes a wireless link.

11. The device of claim 1, further comprising a memory in communication with said controller and that includes address information stored therein.

12. The device of claim 11, wherein said address information includes address data associated with the power distribution equipment.

13. The device of claim 11, wherein said address information includes address data associated with another interface device.

14. A system for providing communications for a plurality of power distribution equipment via a power line communication system, comprising:
a computer system including executable program code executable to generate control messages for controlling the plurality of power distribution automation equipment;
a plurality of interface devices, wherein each interface device is communicatively coupled to one or more of the plurality of power distribution equipment; and
wherein said computer system is configured to transmit control messages to the plurality of power distribution equipment via a communication path that includes one or more power lines and said plurality of interface devices.

15. The system of claim 14, wherein each said interface device includes a controller configured to control the flow of data to the power distribution equipment to which said interface device is communicatively coupled.

16. The system of claim 14, wherein at least some of said interface devices are connected to multiple pieces of power distribution equipment.

17. The system of claim 14, wherein at least some of said interface devices are communicatively coupled to a fiber optic conductor for communicating via the power line communication system.

18. The system of claim 17, wherein at least some of said interface devices include a first fiber optic port, a second fiber optic port, and a data switch communicatively coupled to said first and second fiber optic ports.

19. The system of claim 14, wherein at least some of said interface devices are communicatively coupled to a low voltage power line for communicating via the power line communication system.

20. The system of claim 14, wherein at least one of the control messages comprises a request for status information.

21. The system of claim 14, wherein the communication path includes a medium voltage power line.

22. The system of claim 14, wherein said computer system includes a memory having data of the status of the plurality of power distribution equipment stored therein.

23. The system of claim 14, wherein said computer system includes a memory having address information associated with each of said plurality of interfaces devices stored therein.

24. The method of claim 14, wherein the first data corresponds to the control message.

25. An interface device for interfacing power distribution equipment to a power line communication system, comprising:
a network interface configured to communicate over the power line communication system;
an equipment interface configured to communicate with the power distribution equipment;
a controller in communication with said equipment interface and said network interface;
wherein said controller includes a memory that includes address information stored therein; and
wherein said address information includes address data associated the power distribution equipment.

26. The device of claim 25, wherein said network interface includes a first fiber optic port.

27. The device of claim 26, wherein said network interface further includes a second fiber optic port and a data switch communicatively coupled to said first and second fiber optic ports.

28. The device of claim 27, wherein said data switch is communicatively coupled to said controller.

29. The device of claim 25, wherein said network interface is configured to communicate over a low voltage power line.

30. The device of claim 25, further comprising a wireless transceiver communication coupled to said controller.

31. The device of claim 25, wherein said equipment interface communicates with the power distribution equipment via a path that includes a wireless link.

32. The device of claim 25, wherein the power line communication system comprises a broadband communication system that provides internet access to a plurality of user devices.
